(19) United States
(12) Patent Application Publication
(10) Pub. No.: US 2022/0334875 A1
(43) Pub. Date: Oct. 20, 2022

(54) SELECTION OF CANDIDATE COMPUTING DEVICE TO REPLACE TARGET COMPUTING DEVICE

(71) Applicant: Hewlett-Packard Development Company, L.P., Spring, TX (US)

(72) Inventors: Maikel Maciel Ronnau, Porto Alegre (BR); Jonas da Silveira Bohrer, Porto Alegre (BR)

(21) Appl. No.: 17/232,722

(22) Filed: Apr. 16, 2021

(51) Int. Cl. G06F 9/50; G06F 11/30; G06F 11/34; G06F 9/48

(52) U.S. Cl. CPC G06F 9/505; G06F 11/3006; G06F 11/3495; G06F 9/4856

(57) ABSTRACT

That an actual resource utilization of a target computing device is greater than a baseline resource utilization of the target computing device is determine. A candidate computing device of a different type than the target computing device and having a baseline resource utilization lower than the actual resource utilization of the target computing device is responsively selected. Whether a baseline utilization profile of the candidate computing device matches an actual utilization profile of the target computing device is determined. Responsive to determining that the baseline utilization profile of the candidate computing device matches the actual utilization profile of the target computing device, an action is performed in relation to the candidate computing device to replace the target computing device.

### BACKGROUND

Computing devices include server, desktop, laptop, and notebook computers, as well as other types of computing devices, including smartphones, tablet computing devices, and so on. Computing devices are commonly employed to run workloads of a variety of different application computer programs, which can be referred to as simply applications. A computing device utilizes its resources, including hardware resources such as processors, memory, networking hardware, and storage devices, to run application workloads.

### BRIEF DESCRIPTION OF THE DRAWINGS

FIG. 1 is a diagram of an example system in which telemetric data of computing devices is collected and on which basis a candidate computing device can be selected to replace a target computing device.

FIG. 2 is a flowchart of an example method for selecting a candidate computing device to replace a target computing device.

FIG. 3 is a graph of example computing device resource utilization on which basis a candidate computing device can be selected to replace a target computing device.

FIG. 4 is a chart of example application per-resource utilizations of a candidate computing device and a target computing device, on which basis whether the candidate computing device should replace the target computing device can be determined.

FIG. 5 is a chart of example application overall resource utilizations of a candidate computing device and a target computing device, on which basis whether the candidate computing device should replace the target computing device can be determined.

FIG. 6 is a flowchart of an example method.

FIG. 7 is a diagram of an example non-transitory computer-readable data storage medium.

FIG. 8 is a block diagram of an example computing device.

### DETAILED DESCRIPTION

As noted in the background, a computing device utilizes resources, such as hardware resources, to run workloads of applications. How well the computing device runs the application workloads depends on the specific applications that are run, as well as the specific workloads of these applications. The application workloads can include how the applications are used on the computing device, how often the applications are used, and so on. That is, the application workloads can include which and for how long applications are run over time on the computing device, as well as how the applications are used when they are running.

In general, a computing device having better hardware specifications, such as a faster graphics and/or central processor or more processor cores, faster or more memory, faster networking capability, and faster storage devices or greater storage device capacity, will run application workloads with better performance than a computing device having worse hardware specifications. However, it can be difficult for a user to determine whether to replace his or her computing device with a different computing device. For example, the user may be unable to discern whether his or her existing computing device already has good performance with respect to the application workloads that the user has actually been running on the computing device, and/or whether a different computing device will markedly improve such application workload performance.

Techniques described herein ameliorate these issues. The actual resource utilization of a target computing device of a user is compared to its baseline resource utilization, which is indicative of the actual resource utilizations of computing devices of the same type as the target computing device as used by others. If the actual resource utilization of the target computing device is greater than its baseline resource utilization, then a candidate computing device having a type different than the target computing device is selected. The candidate computing device that is selected has a baseline resource utilization lower than the actual resource utilization of the target computing device. The baseline resource utilization of the candidate computing device is indicative of the actual resource utilizations of computing devices of the same type as the candidate computing device.

The baseline utilization profile of the candidate computing device is compared to the actual utilization profile of the target computing device. The actual utilization profile of the target computing device is indicative of how the user is using the target computing device, such as the application workloads that the user is running on the target computing device. The baseline utilization profile of the candidate computing device is indicative of how others are using computing devices of the same type as the candidate computing device. If the baseline utilization profile of the candidate computing device matches the actual utilization profile of the target computing device, then an action is performed in relation to the candidate computing device to replace the target computing device.

Therefore, in one implementation, a target computing device may be replaced with a candidate computing device, or a recommendation may be provided indicating that replacement of the target device with the candidate device be considered so long as two conditions have been satisfied. First, the actual resource utilization of the target computing device has to be greater, or higher, than the baseline resource utilization of the target computing device (i.e., the baseline resource utilization of computing devices of the same type as the target computing device). Second, the actual utilization profile of the target computing device has to match the baseline utilization profile of the selected candidate computing device (i.e., the baseline utilization profile of computing devices of the same type as the selected candidate computing device).

If the first condition is met but not the second condition, then a different selected candidate computing device also having a baseline resource utilization lower than the target computing device's actual resource utilization may be selected that does satisfy the second condition. However, if the first condition is not met, then no candidate computing device may be selected to replace the target computing device. That is, if the actual resource utilization of the target computing device is lower than the target computing device's baseline resource utilization, the techniques described herein deem that the target computing device should not be replaced.

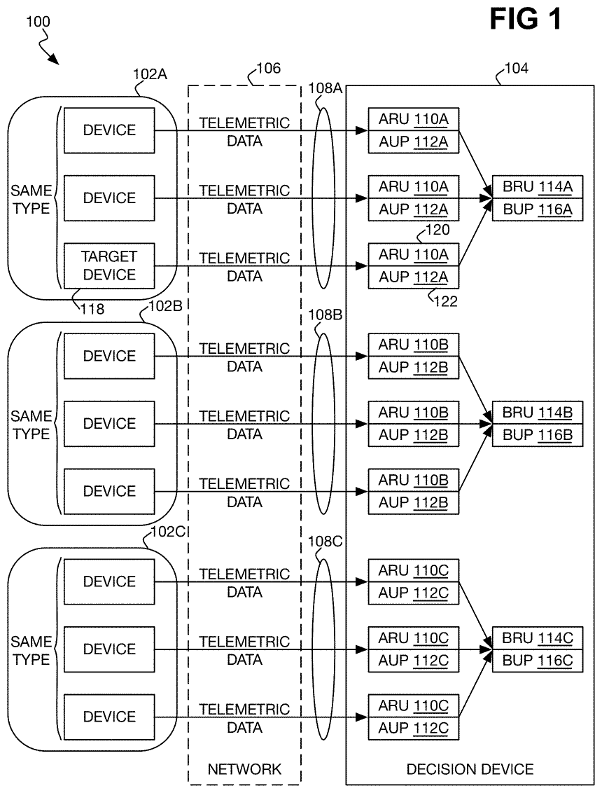

FIG. 1 shows an example system 100 including a set of computing devices 102A, a set of computing devices 102B, and a set of computing devices 102C. The computing devices 102A, 102B, and 102C are collectively referred to as the computing devices 102. Examples of the computing devices 102 include server, desktop, laptop, and notebook computers, as well as other types of computing devices, including smartphones, tablet computing devices, and so on.

The computing devices 102A are of the same type; the computing devices 102B are of the same type; and the computing devices 102C are of the same type. However, the type of the computing devices 102A differs from the type of the computing devices 102B and from the type of the computing devices 102C. Similarly, the type of the computing devices 102B differs from the type of the computing devices 102C.

Each set of computing devices 102 may be of the same type in that they have the same (i.e., identical) hardware specifications. For example, each set of computing devices 102 may have the same number and type of central and/or graphics processors, the same amount and type of memory, the same number and type of networking hardware, and the same amount and type of storage devices. Each set of computing devices 102 may thus have the same manufacturer stock-keeping unit (SKU) in this respect.

In the example of FIG. 1, there are three sets of computing devices 102. However, in actuality, there may be many more than three such sets of computing devices 102 of different types, such as tens, hundreds, or more sets of computing devices 102. Similarly, in the example, each set includes three computing devices 102. However, in actuality, each set may include many more than three computing devices 102, such as tens, hundreds, thousands, or more computing devices 102.

The computing devices 102 are communicatively connected to what is referred to as a decision computing device 104, over a network 106. The decision computing device 104 is a server computing device that collects information from the computing devices 102, and determines whether to replace a target computing device 118 with a computing device 102 of a different type. The network 106 can be or include the Internet, for instance, as well as local-area networks (LANs), wide-area networks (WANs), wired networks, wireless networks, intranets, extranets, and so on.

Each computing device 102A may run an agent computer program that respectively collects telemetric data 108A indicative of the actual resource utilization 110A of the computing device 102A in question and the actual utilization profile 112A of the computing device 102A. Each computing device 102B may similarly run an agent computer program that respectively collects telemetric data 108B indicative of the actual resource utilization 110B and the actual utilization profile 112B of the computing device 110B in question. Each computing device 102C may similarly run an agent computer program that respectively collects telemetric data 108C indicative of the actual resource utilization 110C and the actual utilization profile 112C of the computing device 110C in question.

The telemetric data 108A, 108B, and 108C collected by the sets of computing devices 102A, 102B, and 102C, respectively, is collectively referred to as the telemetric data 108. The actual resource utilizations 110A, 110B, and 110C are likewise collectively referred to as the actual resource utilizations 110. The actual utilization profiles 112A, 110B, and 110C are collectively referred to as the actual utilization profiles 112.

The telemetric data 108 collected on each computing device 102 can include utilization measurements of hardware resources on that computing device 102, and which applications are running on that computing device 102, over time. That is, the telemetric data 108 collected on a given computing device 102 can include such measurements and which applications are running over consecutive time samples for a given length of time. Each computing device 102 sends its telemetric data 108 to the decision computing device 104 over the network 106.

The decision computing device 104 generates or determines the actual resource utilization 110 and the actual utilization profile 112 of each computing device 102 from the telemetric data 108 collected from that computing device 102. For example, for each different hardware resource for which utilization measurements were collected over consecutive time samples for a given length of time on a computing device 102, the actual resource utilization 110 may be the average utilization of that hardware resource. The telemetric data 108 collected at a computing device 102 is thus indicative of the actual resource utilization 110 of the computing device 102.

The actual utilization profile 112 of a computing device 102 can include the actual application per-resource utilizations of the computing device 102. The actual application per-resource utilizations of a computing device 102 can include, for each application running on the computing device 102 during the given length of time when the telemetric data 108 was collected, the breakdown of actual resource utilization, by resource, for that application. For example, one application running on the computing device 102 may have processor, memory, and storage device utilizations of 50%, 25%, and 25%, respectively, and thus be processor-centric in its resource utilization. By comparison, another application running on the computing device 102 may have processor, memory, and storage device utilizations of 20%, 65%, and 15%, respectively, and thus be memory-centric in its resource utilization. The telemetric data 108 collected at a computing device 102 can thus be indicative of the actual application per-resource utilizations as (or as part of) the actual utilization profile 112 of the computing device 102.

The actual utilization profile 112 of a computing device 102 can additionally or instead include the actual application overall resource utilizations of the computing device 102. The actual application overall resource utilizations of a computing device 102 can include, for each application running on the computing device 102 during the given length of time when the telemetric data 108 was collected, the overall actual resource utilization for that application. For example, one application running on the computing device 102 may utilize 10% of the resources of the computing device 102 on average, whereas another application may utilize 8% of the resources of the computing device 102 on average. The telemetric data 108 collected at a computing device 102 can thus be indicative of the actual application overall resource utilizations as (or as part of) the actual utilization profile 112 of the computing device 102.

The decision computing device 104 therefore generates an actual resource utilization 110 and an actual utilization profile 112 for each computing device 102. That is, each computing device 102 has a respective actual resource utilization 110 and a respective actual utilization profile 112, which are generated from the telemetric data 108 collected at that computing device 102. The actual resource utilization 110 and the actual utilization profile 112 for a computing device 102 are specific to that computing device 102, and do not depend and are not based on the application resource utilization 110 or the actual utilization profile 112 of any other computing device 102.

For the set of computing devices 102A, the decision computing device 104 further generates a baseline resource utilization 114A from the actual resource utilizations 110A of those computing devices 102A, and a baseline utilization profile 116A from the actual utilization profiles 112A of those computing devices 102A. For the set of computing devices 102B, the decision computing device 104 similarly generates a baseline resource utilization 114B and a baseline utilization profile 116B from the actual resource utilizations 110B and the actual utilization profiles 112B, respectively, of those computing devices 102B. For the set of computing devices 102C, the decision computing device 104 generates a baseline resource utilization 114C and a baseline utilization profile 116C from the actual resource utilizations 110C and the actual utilization profiles 112C, respectively, of those computing devices 102C.

The baseline resource utilizations 114A, 114B, and 114C are collectively referred to as the baseline resource utilizations 114, and the baseline utilization profiles 116A, 116B, and 116C are collectively referred to as the baseline utilization profiles 116. The baseline resource utilization 114 and the baseline utilization profile 116 of a given computing device 102 are the baseline resource utilization 114 and the baseline utilization profile 116, respectively, of computing devices 102 of the same type as the computing device 102 in question. Therefore, each computing device 102 of the same type has the same baseline resource utilization 114 and the same baseline utilization profile 116. For example, each computing device 102A has the same baseline resource utilization 114A and the same baseline utilization profile 116A, even though each computing device 102A has its own actual resource utilization 110A and its own actual utilization profile 112A.

The decision computing device 104 can generate or determine the baseline resource utilization profile 116 for the computing devices 102 of the same type from the actual resource utilizations 110 of these computing devices 102 in a number of different ways. For example, the actual resource utilizations 110 of the computing devices 102 in question may be averaged by hardware resource to generate the baseline resource utilization profile 116 for these computing devices 102. As another example, the actual resource utilizations 110 of the computing devices 102 in question may be clustered using k-means or another clustering technique to determine the baseline resource utilization profile 116 for these computing devices 102.

The decision computing device 104 can similarly generate or determine the baseline utilization profile 116 for the computing devices 102 of the same type from the actual utilization profiles 112 of these computing devices 102 in a number of different ways. For example, with respect to the actual application per-resource utilizations of the computing devices 102 in question, for each unique application running on any such computing device 102, the breakdowns of actual resource utilization may be averaged by resource to determine the baseline resource utilization profile 116 (or a portion thereof) for these computing devices 102. Similarly, with respect to the actual application overall resource utilizations of the computing devices 102 in question, for each unique application running on any such computing device 102, the overall actual resource utilizations may be averaged to determine the baseline resource utilization profile 116 (or a portion thereof) for these computing devices 102.

In the example of FIG. 1, one of the computing devices 102A is specifically identified as a target computing device 118. The decision device 104 thus determines whether the target computing device 118 should be replaced, and if so, selects a candidate computing device 102 to replace the target computing device 118. In the example, the target computing device 118 has an actual resource utilization 120 and an actual utilization profile 122 on which basis the decision device 104 generated the baseline resource utilization 114A and the baseline utilization profile 116A, respectively. However, in another implementation, the baseline resource utilization 114A and the baseline utilization profile 116A may have been generated before the actual resource utilization 120 and the actual utilization profile 122 of the target computing device 118 were generated. That is, the baseline resource utilization 114A and the baseline utilization profile 116A are not generated on the basis of the actual resource utilization 120 and the actual utilization profile 122, respectively.

In both cases, the baseline resource utilization 114A and the baseline utilization profile 116A are generated from actual resource utilizations 110A and actual utilization profiles 112A of computing devices 102A of the same type. In the former case, these actual resource utilizations 110A and actual utilization profiles 112A include the actual resource utilization 120 and the actual utilization profile 122 of the target computing device 118, whereas in the latter case they do not. Nevertheless, in each case, the target computing device 118 is said to have the baseline resource utilization 114A and the baseline utilization profile 116A (and in addition to having its own actual resource utilization 120 and its own actual utilization profile 122).

The decision computing device 104 determines that the target computing device 118 should be replaced if the actual resource utilization 110A of the target computing device 118 is greater than the baseline resource utilization 114A of the target computing device 118 (i.e., of computing devices 102A of the same type as the target computing device 118). The actual resource utilization 110A of the target computing device 118 being greater than its baseline resource utilization 114A means that the target computing device 118 is using more hardware resources on average than other computing devices 102A of the same type. As a result, replacement of the target computing device 118 is considered to be appropriate.

If the decision computing device 104 determines that the target computing device 118 should be replaced, it selects a candidate computing device 102 of a different type than the target computing device 118 to replace the target computing device 118. The decision computing device 104 specifically selects a candidate computing device 102 having a baseline resource utilization 114 lower than the actual resource utilization 120 of the target device 118. For instance, the decision computing device 104 may select a computing device 102B or a computing device 102C as the candidate computing device 102, insofar as the computing devices 102B and 102C are of different types than the target computing device 118, if both the computing devices 102B and 102C have baseline resource utilizations 114B and 114C, respectively, lower than the actual resource utilization 120 of the target device 118. For descriptive purposes only, the decision computing device 104 is said to (at least initially) select a computing device 102B as the candidate computing device 102.

In this example, the candidate computing device 102B is an existing computing device 102B having an actual resource utilization 110B and an actual utilization profile 112B from which the baseline resource utilization 114B and the baseline utilization profile 116B, respectively, were generated. However, in another implementation, the candidate computing device 102B may be an existing computing device 102B, but no actual resource utilization 110B or actual utilization profile 112B may have been generated for the computing device 102B. In this case, the baseline resource utilization 114B and the baseline utilization profile 116B of the candidate computing device 102B are thus not generated based on the actual resource utilization 110B and the actual utilization profile 112B, respectively, of the computing device 102B. Rather, the baseline resource utilization 114B and the baseline utilization profile 116B profile are generated from the actual resource utilizations 110B and the actual utilization profiles 112B of other computing devices 102B of the same type as the candidate computing device 102B.

Furthermore, in still another implementation, the candidate computing device 102B may not yet exist. That is, the candidate computing device 102B may be orderable and/or manufacturable, but may not yet have been ordered or manufactured. In this case, too, the baseline resource utilization 114B and the baseline utilization profile 116B of the candidate computing device 102B are not generated based on the actual resource utilization 110B and the actual utilization profile 112B, respectively, of the computing device 102B. Rather, the baseline resource utilization 114B and the baseline utilization profile 116B profile are generated from the actual resource utilizations 110B and the actual utilization profiles 112B of other computing devices 102B of the same type as the candidate computing device 102B.

The decision computing device 104 determines whether the baseline utilization profile 116B of the selected candidate computing device 102B matches the actual utilization profile 122 of the target device 118. The baseline utilization profile 116B may be considered to match the actual utilization profile 122 if the two utilization profiles 116B and 122 are identical within a specified threshold. For example, if the baseline utilization profile 116B has an application per-resource utilization that is identical within a specified threshold percentage to the application per-resource utilization of the actual utilization profile 122 for more than a threshold number of the applications of the actual utilization profile 122, then the utilization profiles 116B and 122 may be considered as matching. As another example, if the baseline utilization profile 116B has an application overall resource utilization that is identical within a specified threshold percentage to the application overall resource utilization of the actual utilization profile 122 for more than a threshold number of the applications of the actual utilization profile 122, then the utilization profiles 116B and 112 may be considered as matching.

If the baseline utilization profile 116B of the selected candidate computing device 102B matches the actual utilization profile 122 of the target computing device 118, then the selected candidate computing device 102B may replace the target computing device 118, or may be offered as a replacement for the target computing device 118. If the baseline utilization profile 116B of the selected candidate computing device 102B does not match the actual utilization profile 122 of the target computing device 118, however, then the decision computing device 104 may select a different candidate computing device 102 having a baseline resource utilization 114 lower than the actual resource utilization 120 of the target computing device 118, such as a candidate computing device 102C. If the baseline utilization profile 116 of this different selected candidate computing device 102 matches the actual utilization profile 122 of the target computing device 118, then this other candidate computing device 102 may replace (or may be offered as a replacement for) the target computing device 118.

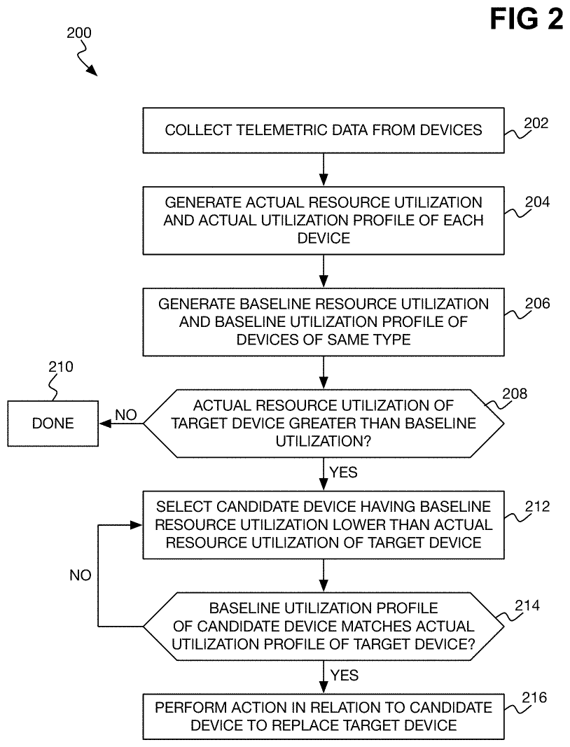

FIG. 2 shows an example method 200 for selecting a candidate computing device to replace a target computing device. The method 200 may be performed by the decision computing device 104 for selecting a candidate computing device 102 to replace the target computing device 118 as has been described in relation to FIG. 1. The method 200 may be implemented as program code stored on a non-transitory computer-readable data storage medium, and executable by a processor of a computing device (e.g., the decision computing device 104).

The method 200 includes collecting telemetric data from computing devices, including from the target computing device (202). The telemetric data of the target computing device may be collected after the telemetric data of the other computing devices have been collected. The method 200 includes generating the actual resource utilization and the actual utilization profile of each computing device (204). The actual resource utilization and the actual utilization profile of the target computing device may be determined after the actual resource utilizations and the actual utilization profiles of the other computing devices have been determined.

The method 200 further includes generating a baseline resource utilization and a baseline utilization profile for computing devices of the same type (206). For each type of computing device, a baseline resource utilization and a baseline utilization profile is determined from the actual resource utilizations and the actual utilization profiles, respectively, of computing devices of that type. The baseline resource utilization and the baseline utilization profile of a computing device are thus the baseline resource utilization and the baseline utilization profile calculated from the actual resource utilizations and the actual utilization profiles, respectively, of (other) computing devices of the same type as the computing device in question.

If the actual resource utilization of the target computing device is not greater than the baseline resource utilization of the target computing device (i.e., the baseline resource utilization of other computing devices of the same type as the target computing device) (208), then the method 200 ends without selecting a candidate computing device to replace the target computing device (210). In this case, the hardware specifications of the target computing device are deemed sufficient for the application workloads that the user of the target computing device has been running on the target computing device. The target computing device is considered for replacement, in other words, just if the target computing device is actually utilizing resources in a greater manner than other computing devices of the same type are, as specified by the baseline resource utilization.

By comparison, if the actual resource utilization of the target computing device is greater than the baseline resource utilization of the target computing device (208), the method 200 includes then selecting a candidate computing device having a baseline resource utilization (i.e., the baseline resource utilization of other computing devices of the same type as the candidate computing device) that is lower than the actual resource utilization of the target computing device (212). The candidate computing device is of a different type of computing device than the target computing device is. If there is more than one (type of) candidate computing device having a baseline resource utilization lower than the actual resource utilization of the target computing device, which (type of) candidate computing device is selected may be achieved in a number of different ways. As one example, the (type of) candidate computing device having the lowest baseline resource utilization may be selected.

If the baseline utilization profile of the candidate computing device does not match the actual utilization profile of the target computing device (214), however, then the method 200 selects a different (type of) candidate computing device (212). Once a candidate computing device has been selected that has a baseline utilization profile matching the actual utilization profile of the target computing device (214), the method 200 includes then performing an action in relation to the selected candidate computing device to replace the target computing device (216). Different types of actions may be performed in this respect.

For example, the application workloads of the target computing device may be transferred to the candidate computing device to replace the target computing device. Such an example action may be suitable in a data center environment, in which there are stand-by candidate computing devices of different types than the target computing device. The decision computing device 104 of FIG. 1 may, for instance, initiate transfer of workloads performed by the applications of the target computing device to corresponding applications of the candidate computing device. This process may include first causing the applications to be installed on the candidate computing device if they are not yet already installed.

As another example, the candidate computing device may be offered to the user of the target computing device. For instance, the candidate computing device may be offered for purchase or other acquisition to the user. Responsive to receiving approval from the user—such as if the user purchases or otherwise acquires the candidate computing device—the candidate computing device may replace the target computing device. In an enterprise environment, for instance, the user may be offered to upgrade his or her device to a candidate computing device that the enterprise has available or that the enterprise can procure for the user, with the candidate computing device subsequently provided to the user to replace his or her targeting computing device upon approval. In a home environment, the user may be sent an email or otherwise provided with an advertisement indicating that the user would benefit from replacing his or her target computing device with the candidate computing device, with an indication as to how the user can purchase the candidate computing device.

The method 200 can be varied in different ways. For example, as has ben described, a candidate computing device that has a baseline resource utilization lower than the actual resource utilization of the target computing device is first selected, and an action is performed in relation replacing the target device with the candidate device so long as the baseline utilization profile of the candidate device matches the actual utilization profile of the target device. However, instead, multiple candidate devices that have baseline resource utilizations lower than the actual resource utilization of the target device may be considered. Of these multiple candidate devices, the candidate device that has a baseline utilization profile that best matches the actual utilization profile of the target device may be selected.

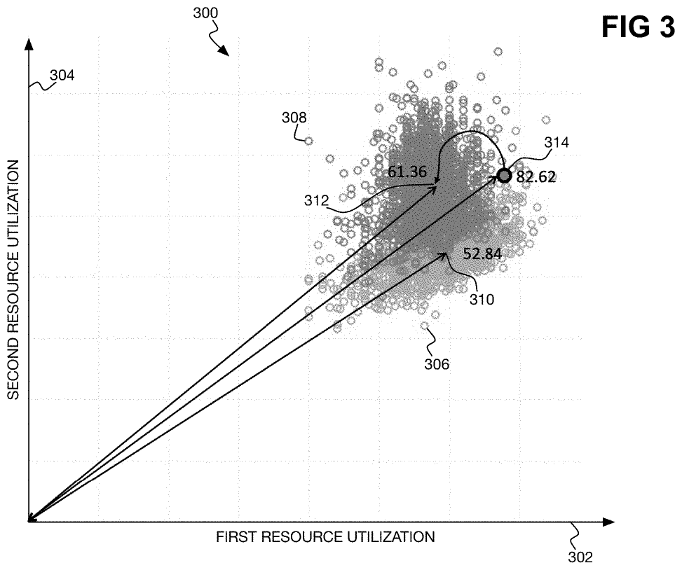

FIG. 3 shows a graph 300 of example computing device resource utilization on which basis a candidate computing device can be selected to replace a target computing device. The graph 300 defines a two-dimensional (2D) space having dimensions 302 and 304 that respectively correspond to different first and second resources. The description herein in relation to the graph 300 can be extended, however, to multidimensional spaces having more than two dimensions that each correspond to a different resource. In FIG. 3, the lighter points 306 correspond to computing devices of a first type, and the darker points 308 correspond to computing devices of a different, second type.

Each point 306 corresponds to the actual utilization of a respective computing device of the first type for the different resource of each dimension 302 and 304. That is, for a given computing device of the first type, there is a point 306 having a value in the dimension 302 equal to this computing device's actual utilization of the first resource to which the dimension 302 corresponds and having a value in the dimension 304 equal to this computing device's actual utilization of the second resource to which the dimension 304 corresponds. Similarly, each point 308 corresponds to the actual utilization of a respective computing device of the second type for the different resource of each dimension 302 and 304. For a given computing device of the second type, there is therefore a point 308 having values in the dimensions 302 and 304 equal to this computing device's actual utilization of the first and second resources, respectively.

A baseline point 310 is determined for the computing devices of the first type. In the example, the baseline point 310 is a center point of the points 306 within the graph 300. A baseline point 312 is similarly determined for the computing devices of the second type. In the example, the baseline point 312 is a center point of the points 308 within the graph 300. Therefore, whereas the points 306 and 308 correspond to the actual resource utilization of computing devices of the first and second types, respectively, the baseline points 310 and 312 correspond to the baseline resource utilization of the computing devices of the first and second types, respectively.

A target computing device in the example is of the same first type as the computing device having the points 306. The target computing device specifically has a target point 314 corresponding to the actual utilization of a respective computing device of the first type for the different resource of each dimension 302 and 304. The target point 314 may be one of the points 306 from which the baseline point 310 was calculated, or may not be one of the points 306 if the actual resource utilization of the target computing device to which the target point 314 corresponds was determined after the baseline point 310 was calculated as the baseline resource utilization of the computing devices of the first type.

In either case, the target computing device nevertheless is considered to have the baseline point 310 as its baseline resource utilization, insofar as the baseline point 310 is calculated for (other) computing devices of the same (first) type. The determination of the points 306, 310, and 314 may be performed as part of determining whether the actual resource utilization of the target computing device is greater than its baseline resource utilization. The determination of the points 306 and 314 may be performed in part 204 of FIG. 2, and the determination of the baseline point 310 may be determined in part 206.

The target computing device has an actual resource utilization greater than its baseline resource utilization. This is because the target point 314 is farther from the origin of the two-dimensional space of the graph 300 than the baseline point 310 is. Stated another way, the target computing device is determined as having an actual resource utilization greater than its baseline resource utilization by determining that the target point 314 is farther from the origin than the baseline point 310 is. In the example, for instance, the distance from the origin to the target point 314 is a normalized unitless distance of 82.62, whereas the distance from the origin to the baseline point 310 is a normalized unitless distance of 52.84.

A candidate computing device of the second type is selected in the example. The candidate computing device has the baseline point 312, insofar as it is of the same (second) type as (other) computing devices having the points 308 from which the baseline point 312 was calculated. The candidate computing device may or may not have a corresponding point 308, however. The determination of the points 308 and 312 may be performed as part of selecting the candidate computing device that is of a different type than the target computing device and that has a baseline resource utilization less than the actual resource utilization of the target computing device. The determination of the points 308 may be performed in part 204 of FIG. 2, and the determination of the baseline point 312 may be determined in part 206.

The candidate computing device has a baseline resource utilization less than the actual resource utilization of the target computing device. This is because the baseline point 312 is closer to the origin of the two-dimensional space of the graph 300 than the target point 314 is. Stated another way, the candidate computing device that has a baseline resource utilization less than the target computing device's actual resource utilization can be selected by determining that the baseline point 312 is closer to the original than the target point 314 is. In the example, for instance, the distance from the origin to the baseline point 312 is a normalized unitless distance of 61.36, whereas the distance form the origin to the target point 314 is a normalized unitless distance of 82.62.

It is noted that the candidate computing device of the second type may be selected to replace the target computing device even though the candidate computing device has a higher baseline resource utilization than the target computing device. That is, the baseline point 310 corresponding to the baseline resource utilization of the target computing device (i.e., of computing devices of the same first type as the target computing device) is farther from the origin than the baseline point 312 corresponding to the baseline resource utilization of the client computing device (i.e., of computing devices of the same second type as the client computing device) is. The candidate computing device is thus selected on the basis of its baseline resource utilization vis-à-vis the actual resource utilization of the target computing device, and not vis-à-vis the baseline resource utilization of the target computing device.

Selection of such a candidate computing device in this manner may be unintuitive, but nevertheless can yield selection of a suitable candidate computing device to replace the target computing device. That is, even though the baseline resource utilization of the selected candidate computing device is higher than that of the target computing device, the selected candidate computing device may nevertheless have lower resource utilization in running the application workloads of the target computing device than the target computing device. For instance, if the baseline utilization profile of the candidate computing device matches the actual utilization profile of the target computing device, the candidate computing device may still have lower resource utilization in running the application workloads even though the candidate computing device has a higher baseline resource utilization than the target computing device.

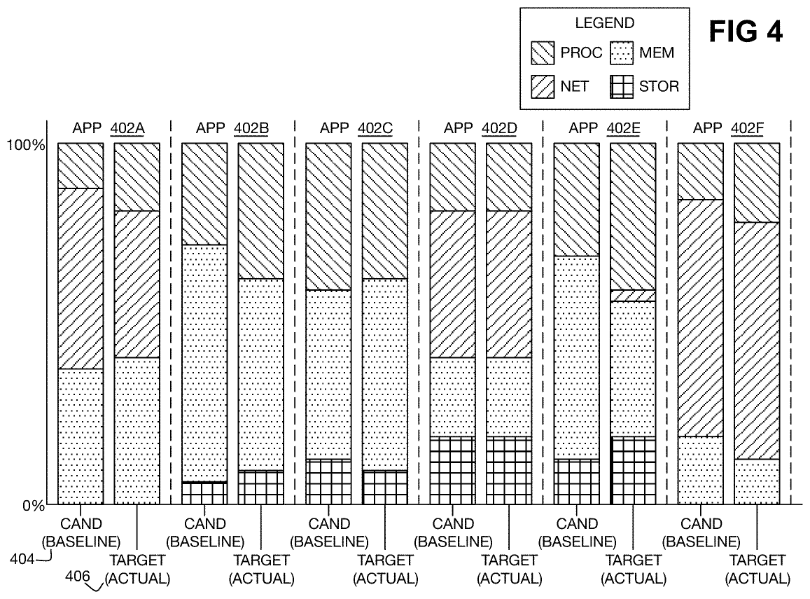

FIG. 4 shows an example of how application per-resource utilizations can be used as a utilization profile on which basis to determine whether a selected candidate computing device should replace a target computing device. For each of a number of different applications 402A, 402B, 402C, 402D, 402E, and 402F, which are collectively referred to as the application 402, the candidate computing device has a baseline application per-resource utilization 404 and the target computing device has an actual application per-resource utilization 406. In the example, there are six such applications 402 for which the candidate and the target computing devices have application works 404 and 406, respectively. However, there may be fewer or more than six applications 402.

Each application per-resource utilization 404 and 406 for each application 402 specifies the relative resource utilization of the application 402 in question for up to four hardware resources: processor resources, network resources, memory resources, and storage resources, as indicated by different shading in FIG. 4. That is, in running a given application 402, computing devices of the same type as the candidate computing device on average relatively utilize resources as indicated by the baseline application per-resource utilization 404 for that application 402. Similarly, in running a given application, the target computing device relatively utilizes resources as indicated by the actual application per-resource utilization 406 for that application 402.

Whether the selected candidate computing device should replace the target computing device is determined based on whether the baseline application per-resource utilizations 404 match the actual application per-resource utilizations 406. For example, for a given application 402, the baseline application per-resource utilization 404 may be considered as matching the actual application per-resource utilization 406 if the percentages of the resources specified by the per-resource utilization 404 are equal to the percentages of the resources specified by the per-resource utilization 406 within a threshold. So long as the baseline application per-resource utilizations 404 match the actual application per-resource utilizations 406 for more than a threshold number of applications 402, the selected candidate computing device should replace the target computing device.

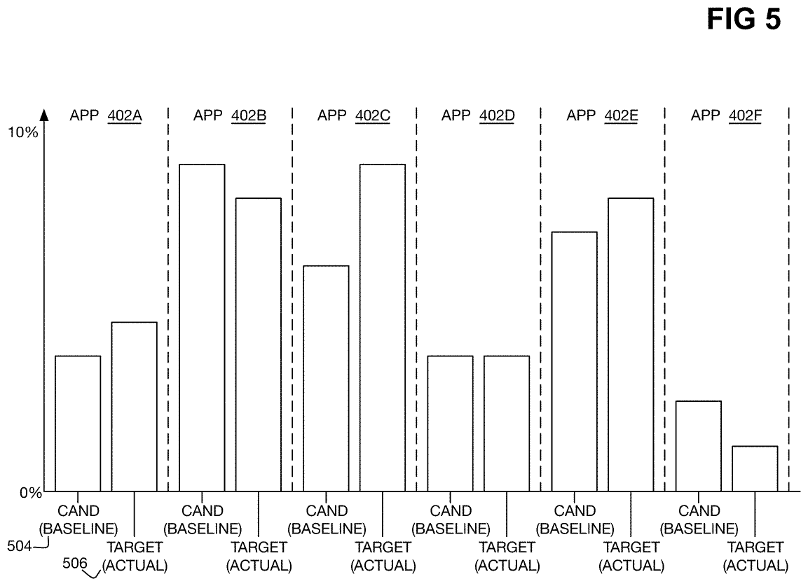

FIG. 5 shows an example of how application overall resource utilizations can be used as a utilization profile on which basis to determine whether a selected candidate computing device should replace a target computing device. For each of a number of different applications 402, the candidate computing device has a baseline application overall resource utilization 504 and the target computing device has an actual application overall resource utilization 506. As in FIG. 4, there may be more or fewer than the six applications 402 depicted in FIG. 5.

Each application overall resource utilization 504 and 506 for each application 402 specifies the overall utilization of the application 402 of the hardware resources of the computing device(s) in question. That is, in running a given application 402, computing devices of the same type as the candidate computing device on average utilize overall resources as indicated by the baseline application overall resource utilization 504 for that application 402. Similarly, in running a given application, the target computing device on average utilizes overall resources as indicated by the actual application overall resource utilization 506 for that application 402. For example, an application overall resource utilization of 5% for a given application 402 means that on average the given application 402 utilizes 5% of the overall resources of computing device(s) in question when running.

Whether the selected candidate computing device should replace the target computing device is determined based on whether the baseline application overall resource utilizations 504 match the actual application overall resource utilizations 506. For example, for a given application 402, the baseline application overall resource utilization 504 may be considered as matching the actual application overall resource utilization 506 if the overall percentage of the former is equal to that of the latter within a threshold. So long as the baseline application overall resource utilizations 504 match the actual application overall resource utilizations 506 for more than a threshold number of applications 402, the selected candidate computing should replace the target computing device.

The application overall resource utilization approach of FIG. 5 can be used in addition to or in lieu of the application per-resource utilization approach of FIG. 4. For example, that the candidate computing device should replace the target computing device may be determined if there is both application per-resource utilization matching per FIG. 4 and application overall resource utilization matching per FIG. 5. As another example, that the candidate computing device should replace the target computing device may be determined so long as there is application per-resource utilization matching or application overall resource utilization matching, even if there is not both types of matching.

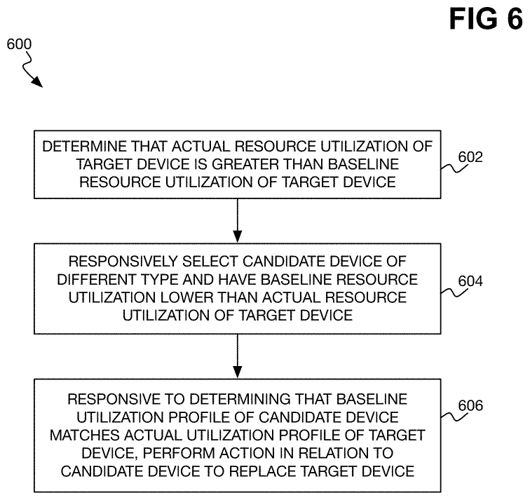

FIG. 6 shows an example method 600. The method 600 may be implemented as program code stored on a non-transitory computer-readable data storage medium and executed by a processor of a computing device. The method 600 includes determining that an actual resource utilization of a target computing device is greater than a baseline resource utilization of the target computing device (602). The method 600 includes responsively selecting a candidate computing device of a different type than the target computing device and having a baseline resource utilization lower than the actual resource utilization of the target computing device (604).

The method 600 includes then determining whether a baseline utilization profile of the candidate computing device matches an actual utilization profile of the target computing device (606). The method 600 includes, responsive to determining that the baseline utilization profile of the candidate computing device matches the actual utilization profile of the target computing device, then performing an action in relation to the candidate computing device to replace the target computing device (608). For instance, the action may be one of the actions that have been described above in relation to FIG. 2.

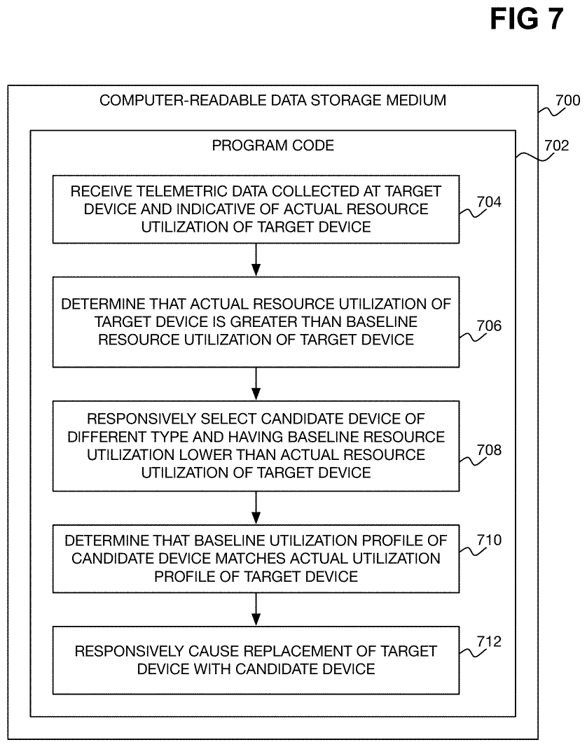

FIG. 7 shows an example non-transitory computer-readable data storage medium 700 storing program code 702 executable by a processor of a computing device to perform processing. The processing includes receiving telemetric data collected at a target computing device (704). The telemetric data is indicative of actual resource utilization of the target computing device. The processing includes determining that the actual resource utilization of the target computing device is greater than a baseline resource utilization of the target computing device (706).

The processing further includes responsively selecting candidate computing devices of a different type than the target computing device and having a baseline resource utilization lower than the actual resource utilization of the target computing device (708). The processing includes determining that a baseline utilization profile of the candidate computing device matches an actual utilization profile of the target computing device (710), and responsively causing replacement of the target computing device with the candidate computing device (712). That replacement of the target computing device with the candidate computing device is caused may include performing any of the actions that have been described above in relation to FIG. 2.

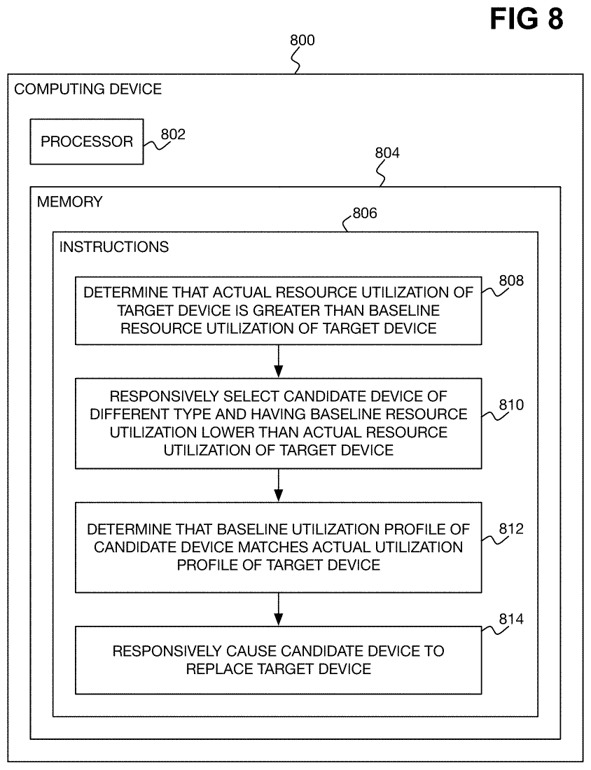

FIG. 8 shows an example computing device 800, such as the decision computing device 104 of FIG. 1. The computing device 800 includes a processor 802 and a memory 804 storing instructions 806 executable by the processor 802. The instructions 806 are executable to determine that an actual resource utilization of a target computing device is greater than a baseline resource utilization of the target computing device (808).

The instructions 806 are executable to responsively select a candidate computing device of a different type than the target computing device and having a baseline resource utilization lower than the actual resource utilization of the target computing device (810). The instructions 806 are executable to further determine that a baseline utilization profile of the candidate computing device matches an actual utilization profile of the target computing device (812), and responsively cause the candidate computing device to replace the target computing device (814). That replacement of the target computing device with the candidate computing device is caused may include performing any of the actions that have been described above in relation to FIG. 2.

Techniques have been described for selecting a candidate computing device to replace a target computing device. A candidate computing device is selected if the target computing device's actual resource utilization is greater than its baseline resource utilization. The selected candidate computing device is of a different type than the target computing device, and has a baseline resource utilization lower than the target computing device's actual resource utilization, regardless of whether the baseline resource utilization of the selected candidate computing device is greater or less than the baseline resource utilization of the target computing device. The selected candidate computing then may replace the target computing device if it has a baseline utilization profile matching the actual utilization profile of the target computing device.

We claim:

1. A method comprising:
determining that an actual resource utilization of a target computing device is greater than a baseline resource utilization of the target computing device;
responsively selecting a candidate computing device of a different type than the target computing device and having a baseline resource utilization lower than the actual resource utilization of the target computing device;
determining whether a baseline utilization profile of the candidate computing device matches an actual utilization profile of the target computing device; and
responsive to determining that the baseline utilization profile of the candidate computing device matches the actual utilization profile of the target computing device, performing an action in relation to the candidate computing device to replace the target computing device.

2. The method of claim 1, wherein performing the action in relation to the candidate computing device to replace the target computing device comprises:
transferring application workloads of the target computing device to the candidate computing device to replace the target computing device.

3. The method of claim 1, further comprising:
responsive to determining that the baseline utilization profile of the candidate computing device does not match the actual utilization profile of the target computing device, selecting a different candidate computing devices of a different type than the computing device and the candidate computing device and having a baseline resource utilization lower than the actual resource utilization of the target computing device;
determining whether the different candidate computing device has a baseline utilization profile matching the actual utilization profile of the target computing device; and
responsive to determining that the baseline utilization profile of the different candidate computing device matches the actual utilization profile of the target computing device, performing an action in relation to the different candidate computing device to replace the target computing device.

4. The method of claim 1, wherein determining that the actual resource utilization of the target computing device is greater than the baseline resource utilization of the target computing device comprises:
determining a target point for the target computing device in multidimensional space having a plurality of dimensions corresponding to different resources, the target point corresponding to the actual resource utilization of the target computing device for the different resource of each dimension;
determining a baseline point for the target computing device in the multidimensional space, the baseline point corresponding to the baseline resource utilization of the target computing device for the different resource of each dimension; and
determining that the target point is farther from an origin of the multidimensional space than the baseline point is.

5. The method of claim 4, wherein determining the baseline point for the target computing device in the multidimensional space comprises:
determining points for respective computing devices of a same type as the target computing device in the multidimensional space, each point corresponding to an actual resource utilization of a respective computing device for the different resource of each dimension; and
determining a center point of the points for the respective computing devices in the multidimensional space, as the baseline point for the target computing device.

6. The method of claim 4, wherein selecting the candidate computing devices comprises:
determining a baseline point for the candidate computing device in the multidimensional space, the baseline point corresponding to the baseline resource utilization of the candidate computing device for the different resource of each dimension; and
determining that the target point is farther from the origin of the multidimensional space than the baseline point for the candidate computing device is.

7. The method of claim 6, wherein determining the baseline point for the candidate computing devices in the multidimensional space comprises:
determining points for respective computing devices of a same type as the candidate computing device in the multidimensional space, each point corresponding to an actual resource utilization of a respective computing device for the different resource of each dimension; and
determining a center point of the points for the respective computing devices in the multidimensional space, as the baseline point for the candidate computing device.

8. The method of claim 1, wherein determining whether the baseline utilization profile of the candidate computing device matches the actual utilization profile of the target computing device comprises either or both of:
determining whether a baseline application overall resource utilization of the candidate computing device matches an actual application overall resource utilization of the target computing device;
determining whether a baseline application per-resource utilization of the candidate computing devices matches an actual application per-resource utilization of the target computing device.

9. The method of claim 1, further comprising:
collecting telemetric data at each of a plurality of first computing devices of a same type as the target computing device;
generating the baseline resource utilization of the target computing device from the telemetric data collected at each first computing device;
collecting telemetric data at each of a plurality of second computing devices of a same type as the candidate computing device; and
generating the baseline resource utilization of the candidate computing device from the telemetric data collected at each second computing device.

10. A non-transitory computer-readable data storage medium storing program code executable by a processor to perform processing comprising:
receiving telemetric data collected at a target computing device, the telemetric data indicative of actual resource utilization of the target computing device;
determining that the actual resource utilization of the target computing device is greater than a baseline resource utilization of the target computing device;
responsively selecting candidate computing devices of a different type than the target computing device and having a baseline resource utilization lower than the actual resource utilization of the target computing device;
determining that a baseline utilization profile of the candidate computing device matches an actual utilization profile of the target computing device; and
responsively causing replacement of the target computing device with the candidate computing device.

11. The non-transitory computer-readable data storage medium of claim 10, wherein responsively causing replacement of the target computing device with the candidate computing devices comprises:
transferring application workloads of the target computing device to the candidate computing device to replace the target computing device.

12. The non-transitory computer-readable data storage medium of claim 10, wherein responsively causing replacement of the target computing device with the candidate computing device comprises:
offering the candidate computing device to a user of the target computing device; and
responsively receiving approval from the user for the candidate computing device.

13. The non-transitory computer-readable data storage medium of claim 10, wherein the baseline utilization profile of the target computing device is generated from telemetric data collected at each of a plurality of computing devices of a same type as the target computing device,
wherein the computing devices and the target computing device are of the same type in that the computing devices and the target computing device each have identical hardware specifications.

14. The non-transitory computer-readable data storage medium of claim 10, wherein the baseline utilization profile of the candidate computing device is generated from telemetric data collected at each of a plurality of computing devices of a same type as the candidate computing device,
wherein the computing devices and the candidate computing device are of the same type in that the computing devices and the candidate computing device each have identical hardware specifications,
and wherein the candidate computing device is of the different type than the target computing device in that the candidate computing device has different hardware specifications than the target computing device.

15. A computing device comprising:
a processor; and
a memory storing instructions executable by the processor to:
determine that an actual resource utilization of a target computing device is greater than a baseline resource utilization of the target computing device;
responsively select a candidate computing device of a different type than the target computing device and having a baseline resource utilization lower than the actual resource utilization of the target computing device;
determine that a baseline utilization profile of the candidate computing device matches an actual utilization profile of the target computing device; and
responsively cause the candidate computing device to replace the target computing device.
